(19) United States
(12) Patent Application Publication
(10) Pub. No.: US 2021/0302214 A1
(43) Pub. Date: Sep. 30, 2021

(54) ROTARY PISTON WATER METER

(71) Applicant: Honeywell International Inc., Morris Plains, NJ (US)

(72) Inventor: Adrian Smith, Stanbridge (GB)

(21) Appl. No.: 16/828,438

(22) Filed: Mar. 24, 2020

(51) Int. Cl. G01F 3/08

(52) U.S. Cl. CPC G01F 3/08

(57) ABSTRACT

A positive displacement fluid flow meter that may have a rotary piston that rotates inside a chamber as a fluid flows through it. The rotating piston may create fixed volume discrete parcels from the passing fluid. The piston may be buoyant relative to the fluid flowing through the meter. Buoyancy of the piston may reduce friction and noise in the meter to result in a more accurate fluid flow measuring meter.

### BACKGROUND

The present disclosure pertains to fluid meters, particularly to efficiencies of such meters.

### SUMMARY

The disclosure reveals a positive displacement fluid flow meter that may have a rotary piston that rotates inside a chamber as a fluid flows through it. The rotating piston may create fixed volume discrete parcels from the passing fluid. The piston may be buoyant relative to the fluid flowing through the meter. Buoyancy of the piston may reduce friction and noise in the meter to result in a more accurate fluid flow measuring meter.

### BRIEF DESCRIPTION OF THE DRAWING

FIGS. 1A, 1B, 1C and 1D are diagrams of a piston designed to run within a chamber;

FIGS. 2A, 2B, 2C and 2D are diagrams including an exploded view of a measuring chamber with an inlet and outlet ports and a piston;

FIGS. 3A and 3B are diagrams that illustrate measurement error in percentage versus flow rate;

FIG. 4 is a diagram of the meter showing a chamber, a top plate, a piston having a buoyant material relative to a measured fluid, and inlet and outlet ports;

FIG. 5 is a diagram of piston material where gravity has a downward force upon the piston material that may be countered by an upward thrust force; and

FIG. 6 is a diagram of a graph showing increased performance due to increased buoyancy of a rotary piston of a positive displacement meter.

### DESCRIPTION

The present system and approach may incorporate one or more processors, mechanical devices, computers, controllers, user interfaces, wireless and/or wire connections, other hardware and software, and/or the like, in an implementation described and/or shown herein. Various implementations not necessarily explicitly mentioned herein may be implemented with the present system and approach.

This description may provide one or more illustrative and specific examples or ways of implementing the present system and approach. There may be numerous other examples or ways of implementing the system and approach.

A rotary piston water meter may use a rotating piston in a chamber which creates fixed-volume discrete parcels from the passing fluid. The meter may be required to work over a range of flows measured in liters per hour. Measuring low flow may be problematic due to the small amount of energy from flowing fluid to drive the piston. Friction between the piston and its chamber base may limit performance.

Water meter performance may be defined by an “R” value (Turn down Ratio) that is a nominal flow rate divided by minimum flow rate within a tolerance band. It may be difficult to produce meters to high “R” values in volume manufacturing in the related art.

For illustrative purposes, one may have two examples of key volumetric meters designated as DN15 (15 mm) and DN20 (20 mm). Other examples may be used. The DN15 may use a piston that revolves 36 times for one liter of water. It appears good at low flows due to its small piston requiring less energy to move it. Its high flow performance may be limited due to its small size. The DN20 may use a piston that revolves 16.5 times for one liter of water. It appears less capable at low flows compared to the DN15 but seems better at high flows. There may be meter limits. The meters may have a maximum performance of R400 (DN15) and R315 (DN20). Manufacturing to these standards on a day to day basis might be challenging.

One main product range may be DN15 and DN20 both using different revolutions per liter chamber assemblies. One may have other product lines with different revs/liter. Competitors may use different revs/liter and chamber sizes. There may be other possible products besides the DN15 and DN20. The present products may be centered around the main product range though, but there may be other sizes.

Noise generated from the rotating piston may limit the markets into which such water meters can be sold. At elevated water temperatures, the piston may seize due to the small clearances required to achieve accuracy. The present approach may be to create a buoyant piston (density less than 1.0 g/cm3) which gives the following benefits, such as reducing friction at low flows and having an R value of 1000 plus prior to a 100 hour endurance. One may change the R value to greater than 1000 prior to approval testing. Then approval values of R800 may be achievable. There may be higher manufacturing yields. One may scope to relax manufacturing tolerances. There is a possibility of a single product to have the current range of R values to cover low flow and high flow accuracies. There may be noise reduction due to increased clearances and less dense material. There may be an increase in thermal capabilities due to increased clearances. The present approach should give high R numbers with “standard” manufacturing and clearances.

The present approach to create a buoyant piston (having a density less than 1.0 g/cm3) should give the following benefits (noted above) to reduce friction at low flows, provide a higher R value as a standard, result in higher manufacturing yields, scope to relax manufacturing tolerances, provide a possibility of a single product to cover the current range, and improve noise reduction and thermal capabilities due to increased clearances.

The present technique may provide a business advantage and/or technical differentiation with higher accuracy as a standard; and if there has been a fall behind in a specification, the technique may allow one to not only catch up but to meet current industry specifications.

Fundamentally, a material change in a product should result in large gains in performance and yield. Further work to capitalize on the large gains of a buoyant piston with new tools or tooling changes may aid in noise reduction, manufacturing, and increase thermal tolerance thereby improving market sales. These factors may relate to water metering volumetric products.

The related art might offer water metering volumetric products with higher specifications than the present product, which can be difficult to produce. A buoyant piston makes it easier to produce volumetric meter products with higher specifications than the related art products. The present approach makes it easy to produce metering volumetric products with higher specifications than the related art products. A buoyant piston may make it easier to produce volumetric meter products with more rigid specifications than the current products.

The present piston and chamber may form a measuring unit and part of a meter assembly. The meter itself typically captures data in a mechanical way using number wheels to display water usage. Some meters may have electronic displays and communication techniques. The meters may be fitted with electronic/software communications to provide remote details such as fluid usage.

A present positive displacement rotary piston water meter may or may not use a buoyant piston. A product line may include volumetric meters (e.g., positive displacement meters). Positive displacement flowmeters may measure volumes of fluid flowing through them by counting repeatedly the filling and discharging of known fixed volumes. A positive displacement flowmeter may incorporate a chamber that obstructs the flow. Inside the chamber, a rotating or reciprocating piston may be placed to create fixed-volume discrete parcels from the passing fluid.

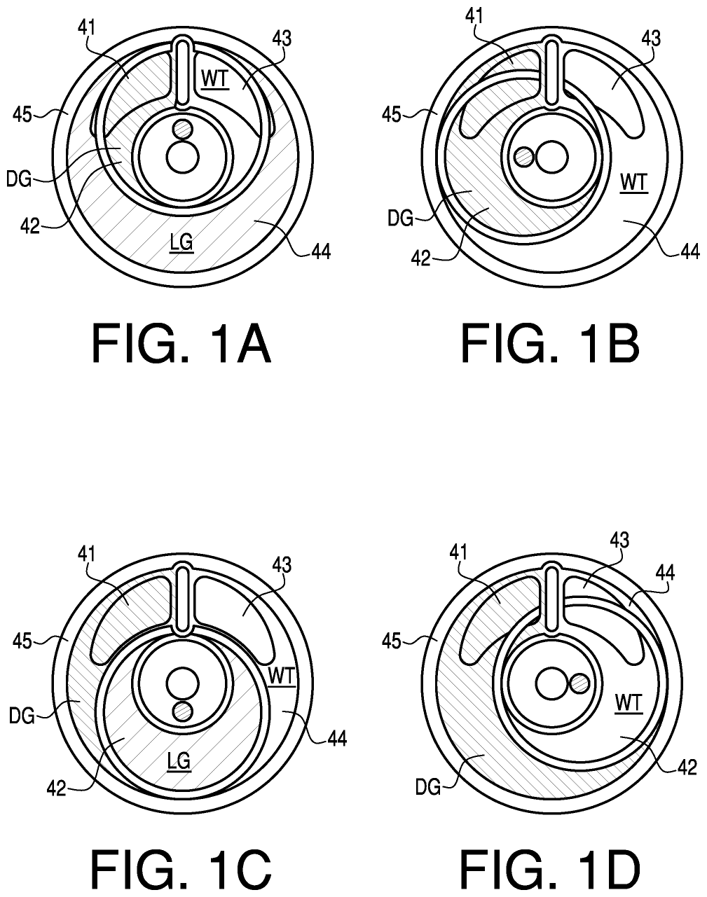

In FIG. 1A, water may flow into a left-hand inlet port 41, filling the inner left half of the piston 42 (shown dark grey (DG)) and causing piston 42 to start to rotate anticlockwise within chamber 45. The movement of piston 42 causes the water in the other inner right half of the piston 42 (shown white (WT)) to exhaust out of a right-hand outlet port 43. Neutral water 44, outside of piston 42 is shown as light grey (LG).

In FIG. 1B, piston 42 has moved counter clockwise round a quarter of its path and the in-flowing water continues to fill the dark grey area inside and also now outside piston 42. The neutral water is now shown white since it is also being exhausted through outlet port 43.

In FIG. 1C, piston 42 has now moved counter clockwise round half of its path. In-flowing water is shown on the inlet port 41 at the left side of chamber 45. Neutral water inside piston 42 is cut off from both ports 41 and 43, and exhaust water continues to be passed through the outlet port 43.

In FIG. 1D, with three-quarters of the piston's cycle completed, piston 42 is just starting to open to inlet port 41 for the beginning of another cycle. The neutral water within the remaining part of the piston has now become exhaust water and the dark grey area in the chamber 45 will soon become neutral water as in the first diagram of FIG. 1A.

The inlet and outlet ports may be located differently than the configurations described herein. For instance, the ports may have the opposite flow directions of the fluid than those examples of the meters disclosed in this description. The piston and the chamber may have configurations, structures and/or shapes different than the examples disclosed in this description. These design features are not intended to restrict the claims.

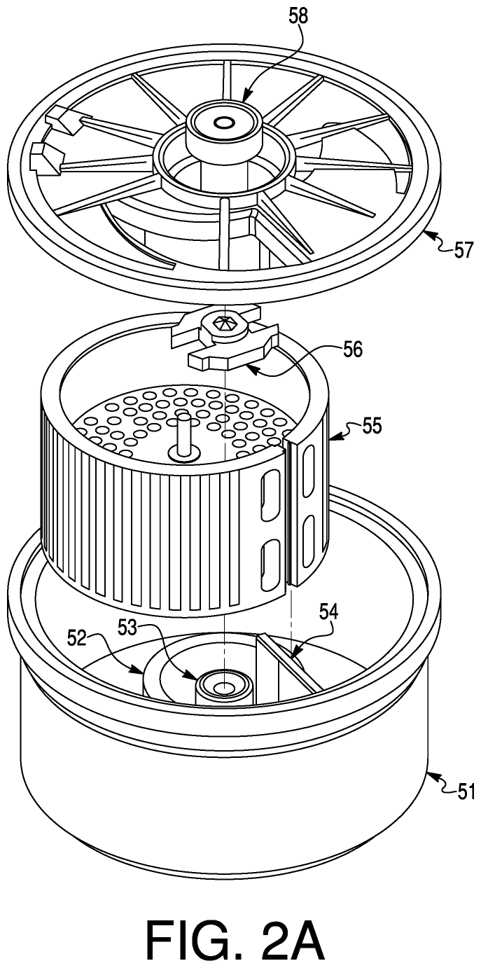

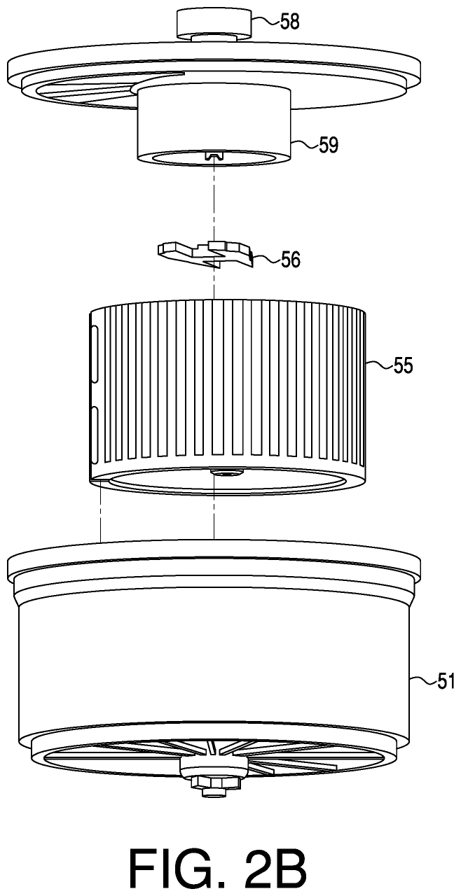

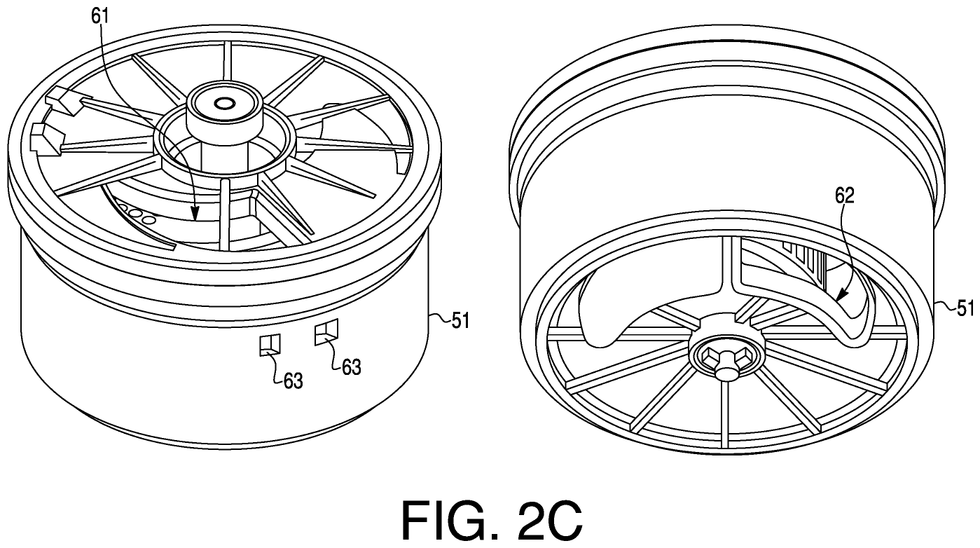

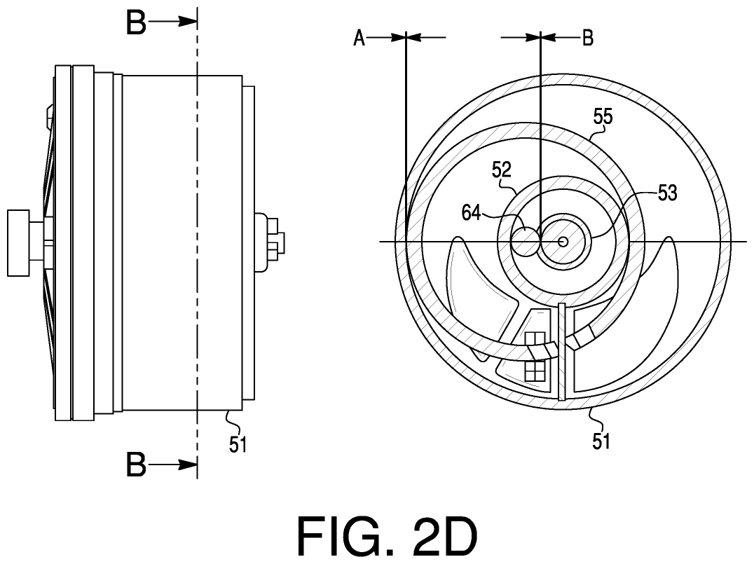

FIG. 2A is an exploded view of the present meter. It may have a chamber 51. There may a chamber hub 52 and chamber shaft 53 within chamber 51. A shutter wall 54 may be situated in chamber 5. A piston 55 may be within chamber 53. A drive bar 56 may be driven by a piston peg. A top plate 57 may be situated over an assembly of the meter. Plate 57 may be regarded as a bottom plate depending on the meter type. There may be a register magnet drive 58 situated at the center of plate 57.

FIG. 2B is a diagram of a side view of the exploded view in FIG. 2A. There is a top hub 59 that may work in conjunction with chamber hub 52.

FIG. 2C is a diagram of top view of chamber 51 with a port 61 that may be an inlet or an outlet for the chamber. Minor side ports 63 may sometimes aid major ports 61 and 62. Also shown is a bottom view of chamber 51 that shows port 62 which may be an outlet or inlet. Some meter chambers may have water entering through a port on top of the chamber and exiting from a port at the bottom of the chamber. Some meters may have water entering from a port at the bottom of the chamber and exiting a port at the top of the chamber. In some cases, inlets and outlets may be on the same surface. In some cases, minor ports may be added on the side face of the chamber to assist the major inlet and outer ports.

FIG. 2D may be a diagram of a section B-B that shows piston radial control faces. Dimension “A” may be controlled by contact between the piston 55 inside diameter and chamber hub 52 outside diameter (at this indicated point) and contact between a piston peg 64 and chamber hub shaft 53 “B”.

The present meter and approach may be a complex constraint system. So an orbiting of the piston may be constrained by an inside diameter of the piston against the outside diameter of the chamber hub and the piston peg against the chamber center shaft. Its orbit may be guided by a chamber divider (wall or shutter) whereby the nose gap of the piston may run along the length or part of the length of the divider. Due to tolerances, the present meter may see a zero gap between the piston outside diameter and the chamber inside diameter which may override the inside diameter of the piston against the outside diameter of the chamber hub. A move going forward may be to eliminate this unpredictable constraint by providing a clearance “X”.

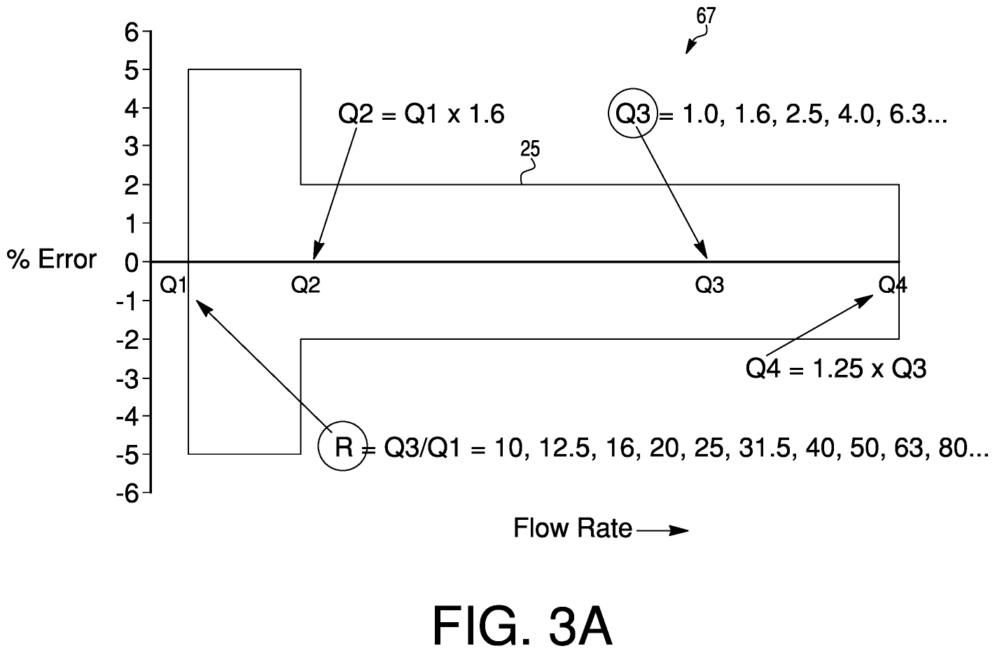

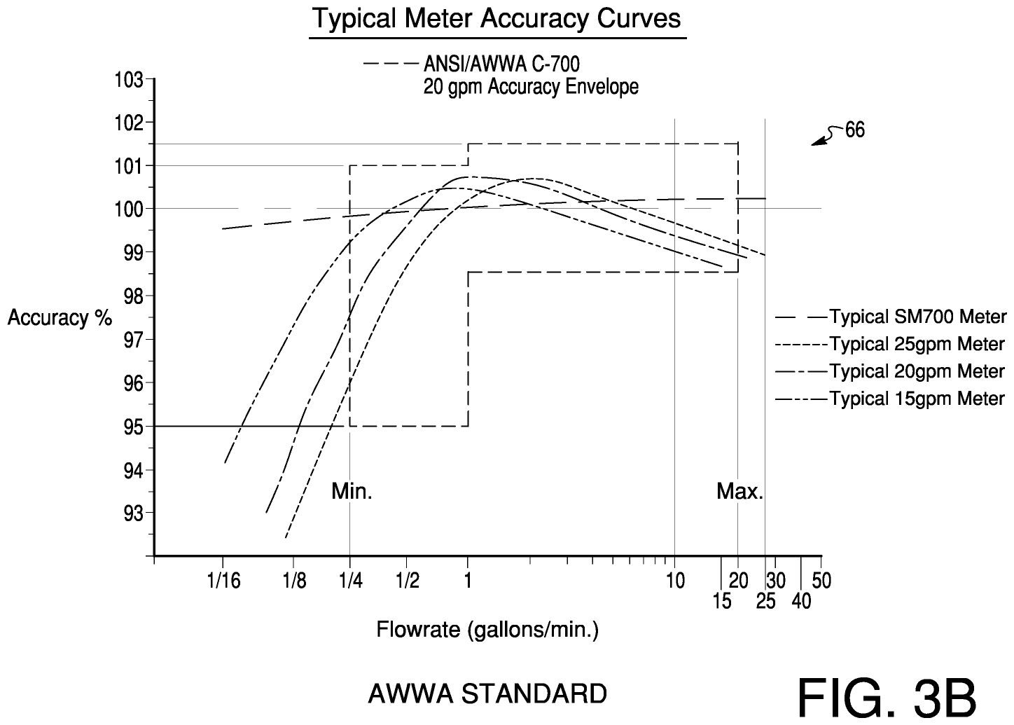

Meter performance may be defined by its accuracy at given flow rates. FIG. 3A is a diagram of a graph 67 that illustrates error in percentage versus flow rate. This is the European Measuring Instrument Directive current system. There are other standards used to measure accuracy such as the AWWA (American Standard) as shown by graph 66 of FIG. 3B, and the old system that was used before the MID. So, Turn Down ratio and various accuracy measurements taken at various flows may all be used. FIG. 3A is what may be used for volumetric domestic meters for European markets. Meter performance may be tested and measured by other ways or methods of various jurisdictions or countries. The illustrations in FIGS. 3A and 3B are just some examples.

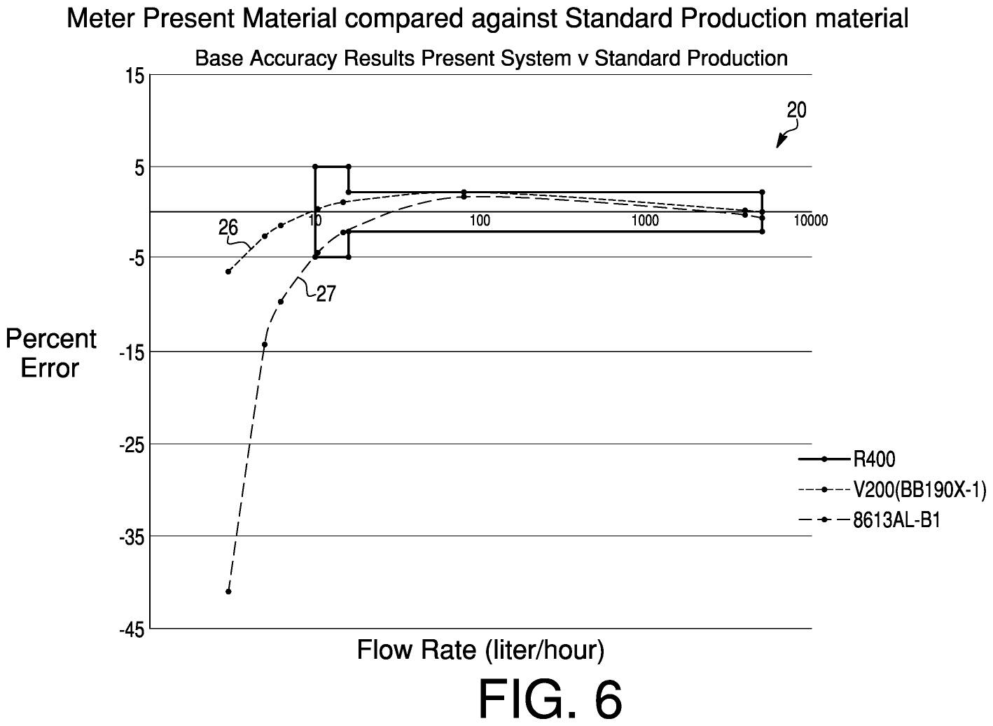

Typically, there appears to be a trade off in accuracy between high and low flows. Some meters may be more accurate at high flows but less accurate at low flows and some meters may be more accurate at low flows but less accurate at high flows. A value called the turndown ratio (R) may be defined by the meter's nominal flow rate divided by its minimum flow rate. Line 25 indicates permitted maximum flow accuracies. At low flows a meter may be permitted to have an accuracy of +/−5% and as the flow increases the accuracy may be limited to +/−2%. With use, a meter's accuracy may degrade ultimately to the point requiring replacement of the meter. FIG. 3A and FIG. 6 may be reviewed in conjunction with each other.

Making piston 11 buoyant while keeping a large reaction force for torque may give greatly increased low flow performance. When a piston is buoyant, much lower flows may start it moving due to vastly reduced friction and drag on the chamber floor. There appear also potential additional benefits such as increased clearances in some areas to improve manufacture yield rates, better thermal limits due to increased clearances, and possible noise reduction due to lower density (smaller contact forces) and greater clearances reducing contact. Creating a buoyant piston may demonstrate that both the low flow accuracy of the DN15 size and the high flow accuracy of the DN20 size can be realized in a modified DN20 buoyant piston giving a superior turndown ratio potential of R1000 or higher compared to circa R400 for existing DN15 and DN20 meters. A low flow accuracy of smaller pistons and a high flow accuracy of larger pistons may be sought with the present system and approach.

The piston is likely to be primarily polystyrene with graphite as a lubricant and glass bubbles to change the density. Other polymers could be used as the primary material. For an illustrative example, piston material may incorporate high impact polystyrene 83.3% with a small amount of PTFE 10% and carbon black 6.7% for color. This material may have a density of approximately 1.2 g/cm3.

Some companies may create and sell a range of polymers including customized compositions. They may have experience in creating materials for buoyancy. They may sell, for example, material formulated for the present requirements. This material may be high impact polystyrene with glass bubbles added which may be obtained from, for example, a commercial company. The addition of glass bubbles 29, or other low density items may reduce the material density to 997 kg/m, making the material buoyant in water. From this material, one may manufacture pistons 11 with instant success showing vast improvements in performance.

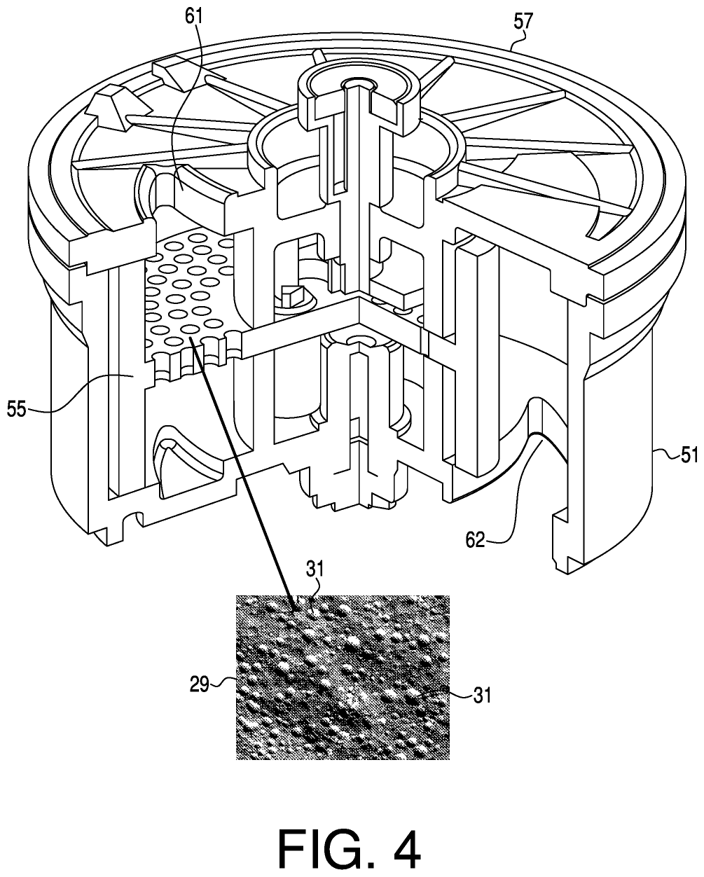

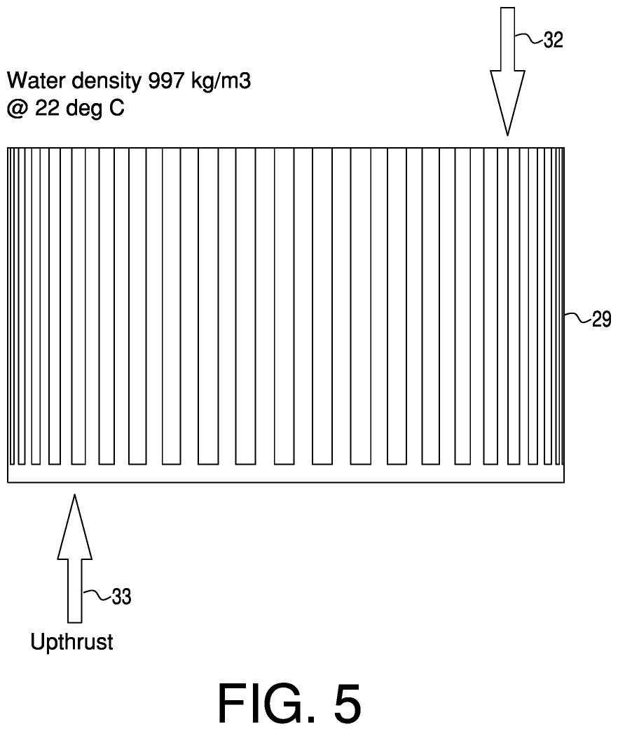

FIG. 4 is a diagram of an example meter showing a chamber 51, a top plate 57, a piston 55 having a material 29 buoyant relative to a measured fluid, an inlet port 61 and outlet port 62. Piston 11 may have a material 29 that incorporates glass bubbles 31 which can increase buoyancy of the piston. Inlet ports may be on the top or bottom of the chamber; likewise, the same is true for the outlet ports. Some meters may have “minor” side ports to assist the major ports. One may use “top plate” and “chamber”, but it may be really top and bottom of the measuring chamber.

FIG. 5 is a diagram of piston material 29 having a density of 997 kg/m3 at 22 degrees C. like that of the metered fluid. Gravity has a force 32 upon material 29 which may be countered by an upward thrust force 33 of the buoyant piston 11. Forces 32 and 33 may cancel each other out thereby result in a piston that exerts nearly minimal vertical force in chamber 13.

FIG. 6 is a diagram of a graph 20 showing increased performance due to increased buoyancy of a rotary piston of a positive displacement meter. A line 26 is of a product having a piston of non-buoyant material. A line 27 is of the same sized product having a replacement buoyant piston.

With appropriate materials and molding, buoyant material may be made using the above noted material incorporating glass bubbles. Other items beside glass bubbles may be used for obtaining buoyant material. The use of a buoyant piston material (density less than 1000 kg/m3) to reduce static and dynamic friction primarily at flows <=15 l/h (liters per hour).

A buoyant piston may allow use of a lower RPL (Rev per Liter) larger piston giving the benefits of less leakage per revolution. An increase in running clearances may improve manufacturability and thermal tolerance.

Water may enter a chamber and cause the piston to orbit around the chamber. Gravity may act on the piston pulling it to the chamber floor. If the density of the piston is greater than water, friction between the piston and chamber floor may be significant and should be reduced. At low flows, friction between the chamber floor and piston has a negative effect on accuracy. If the piston is buoyant, friction particularly at low flows may be reduced.

Introducing additives to the piston material, in this case glass bubbles, may reduce the overall piston density. “Tuning” ratios of piston materials will give different densities and can be mixed to give a density less than water creating a buoyant piston.

In general, the use of a buoyant piston material (density less than 1.0 g/cm3 may reduce static and dynamic friction primarily at flows <=15 l/h; a buoyant piston may allow use of a lower RPL (Revs Per Litre) larger piston giving the benefits of less leakage per revolution; and the buoyant piston material may allow an increase in running clearances improving manufacturability and thermal tolerance.

To recap, a fluid meter may incorporate a chamber having an internal diameter, closed at a first end with a first structure and closed at a second end with a second structure which can be part of the chamber, and the chamber having a hub situated on the second structure, that is concentric with the chamber, and an inner piston that orbits in a path constrained by an external diameter of the piston against the internal diameter of the chamber, and the piston having a peg against a center shaft of the chamber, the piston having an orbit guided by a divider wall of the chamber, and the piston having a nose gap that can run along a length or part of the length of the divider, and between the internal diameter of the chamber and the external diameter of the piston is an X gap. X may be equal to or greater than zero. A fluid may enter the chamber through an input port in the first or second structure or side faces of the chamber, and exit the chamber through an output port in the first or second structure or side faces of the chamber, and for one rotation of the piston in the chamber caused by a flow of fluid into the inlet port, with a flow of the fluid out of the outlet port, there is a fixed-volume discrete parcel of fluid for each rotation of the piston.

The piston may be subject to a force of gravity. The piston may be subject to a force of thrust from the fluid entering the chamber. The force of gravity and the force of thrust may be equal or unequal relative to each other just sufficient to ensure buoyance.

The piston may have a buoyance relative to the fluid.

The fluid may be water.

The piston may incorporate a material to which additives are added to change a density of the material and consequently that of the piston.

The piston may have a buoyance that is adjusted by adding glass bubbles or subtracting glass bubbles to or from, respectively, a base material of the piston.

An approach for measuring a flow of fluid may incorporate forcing a fluid into a round chamber having an inside diameter, the round chamber having a round piston with an external diameter smaller than the inside diameter of the chamber, the round piston thereby being forced by the fluid, to roll inside of the chamber, the piston having an external curved surface at a first distance from the inside curved surface of the chamber, and the piston having an axis of rotation that follows a circular path concentric to a central axis of the chamber. The axes of the chamber and the piston may be vertical and parallel to each other. The piston may be buoyant relative to the fluid to prevent a gravity force pushing the piston down toward the bottom of the chamber that increases friction between the piston and the bottom of the chamber, and results in erroneous measurements of the fluid flow based on rotations of the piston in the chamber, which create discrete parcels of the passing fluid to be counted for a measurement of fluid flow.

The density of the piston may be between plus and minus two percent different than a density of the passing fluid to ensure a predetermined buoyance.

The first distance between the external curved surface of the piston and the inside curved surface of the chamber may be equal to or greater than zero mm and have a variation of up to plus and minus ten percent of a selected first distance.

The piston may incorporate a mixture of materials that includes a thermoplastic and one or more additives that can alter a density of the mixture, strength or lubricity of the materials.

An additive may be used to attain a predetermined buoyancy of the piston relative to the fluid.

Glass bubbles may be an additive to decrease the density of the mixture of materials or graphite can be an additive as a lubricant.

The fluid may be water.

A fluid flow measuring system may incorporate a piston fluid meter having a rotary piston situated in a chamber that creates fixed volume discrete parcels of passing fluid. The rotary piston may have a buoyancy in the passing fluid.

The density of the rotary piston may be between plus or minus two percent different than the density of the passing fluid.

The rotary piston may have a density that is less than the density of the passing fluid.

The material of the piston may be mostly a thermoplastic with the remaining material of the piston that comprises specified amount of additives to obtain a predetermined density, strength or lubricity.

The additives may contain graphite as a lubricant.

An additive may incorporate glass bubbles to decrease the density of the rotary system piston.

A clearance between the rotary piston and the chamber may be between 0.0 mm and 5.0 mm.

Any publication or patent document noted herein may hereby be incorporated by reference to the same extent as if each individual publication or patent document was specifically and individually indicated to be incorporated by reference.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A fluid meter comprising:
a chamber having an internal diameter, closed at a first end with a first structure and closed at a second end with a second structure which can be part of the chamber, and the chamber having a hub situated on the second structure, that is concentric with the chamber; and
an inner piston that orbits in a path constrained by an external diameter of the piston against the internal diameter of the chamber, and the piston having a peg against a center shaft of the chamber, the piston having an orbit guided by a divider wall of the chamber, and the piston having a nose gap that can run along a length or part of the length of the divider, and between the internal diameter of the chamber and the external diameter of the piston is an X gap; and
wherein:
X is equal to or greater than zero;
a fluid can enter the chamber through an input port in the first or second structure or side faces of the chamber, and exit the chamber through an output port in the first or second structure or side faces of the chamber; and
for one rotation of the piston in the chamber caused by a flow of fluid into the inlet port, with a flow of the fluid out of the outlet port, there is a fixed-volume discrete parcel of fluid for each rotation of the piston.

2. The fluid meter of claim 1, wherein:
the piston is subject to a force of gravity; and
the piston is subject to a force of thrust from the fluid entering the chamber; and
wherein the force of gravity and the force of thrust are equal or unequal relative to each other just sufficient to ensure buoyance of the piston.

3. The fluid meter of claim 1, wherein the piston has a buoyance relative to the fluid.

4. The fluid meter of claim 1, wherein the fluid is water.

5. The fluid meter of claim 1, wherein the piston comprises a material to which additives are added to change a density of the material and consequently of the piston.

6. The fluid meter of claim 1, wherein the piston has a buoyance that is adjusted by adding glass bubbles or subtracting glass bubbles to or from, respectively, a base material of the piston.

7. A method for measuring a flow of fluid comprising:
forcing a fluid into a round chamber having an inside diameter, the round chamber having a round piston with an external diameter smaller than the inside diameter of the chamber, the round piston thereby being forced by the fluid, to roll inside of the chamber, the piston having an external curved surface at a first distance from the inside curved surface of the chamber, and the piston having an axis of rotation that follows a circular path concentric to a central axis of the chamber; and
wherein:
the axes of the chamber and the piston are vertical and parallel to each other;
the piston is buoyant relative to the fluid to prevent a gravity force pushing the piston down toward the bottom of the chamber that increases friction between the piston and the bottom of the chamber, and result in erroneous measurements of the fluid flow based on rotations of the piston in the chamber, which create discrete parcels of the passing fluid to be counted for a measurement of fluid flow.

8. The method of claim 7, wherein the density of the piston is between plus and minus two percent different than a density of the passing fluid to ensure a predetermined buoyance.

9. The method of claim 7, wherein the first distance between the external curved surface of the piston and the inside curved surface of the chamber is equal to or greater than zero mm and having a variation of plus and minus ten percent of a selected first distance.

10. The method of claim 7, wherein the piston comprises a mixture of materials that include a thermoplastic and one or more additives that can alter a density of the mixture, strength or lubricity of the materials.

11. The method of claim 10, wherein an additive is used to attain a predetermined buoyancy of the piston relative to the fluid.

12. The method of claim 10, wherein glass bubbles can be an additive to decrease the density of the mixture of materials or graphite can be an additive as a lubricant.

13. The method claim 11, wherein the fluid is water.

14. A fluid flow measuring system comprising:
a piston fluid meter having a rotary piston situated in a chamber that creates fixed volume discrete parcels of passing fluid; and
wherein the rotary piston has buoyancy in the passing fluid.

15. The system of claim 14, wherein the density of the rotary piston is between plus or minus two percent different than the density of the passing fluid.

16. The system of claim 14, wherein the rotary piston has a density that is less than the density of the passing fluid.

17. The system of claim 14, wherein the material of the piston is mostly a thermoplastic with a remaining material of the piston that comprises specified amount of additives to obtain a predetermined density, strength or lubricity.

18. The system of claim 17, wherein the additives contain graphite as a lubricant.

19. The system of claim 17, wherein an additive comprises glass bubbles to decrease the density of the rotary system piston.

20. The system of claim 14, wherein a clearance between the rotary piston and the chamber is between 0.0 mm and 5.0 mm.
